(19) United States
(12) Patent Application Publication
(10) Pub. No.: US 2003/0028267 A1
(43) Pub. Date: Feb. 6, 2003

(54) Method and system for controlling setpoints of manipulated variables for process optimization under constraint of process-limiting variables

(76) Inventors: Michael L. Hales, Salt Lake City, UT (US); Randy A. Ynchausti, Centerville, UT (US); Lynn B. Hales, Salt Lake City, UT (US); Kenneth S. Gritton, Murray, UT (US)

Correspondence Address: Gary R. Maze, Duane, Morris & Heckescher LLP, One Greenway Plaza, Suite 500, Houston, TX, 77046, US

(21) Appl. No.: 09/922,968

(22) Filed: Aug. 6, 2001

(51) Int. Cl. G05B 13/02; G05B 21/02

(52) U.S. Cl. 700/46; 700/30; 700/31; 700/73; 700/74; 700/28

(57) ABSTRACT

A system, method, and article of manufacture suitable for determining setpoints of the control variables to optimize the process while taking into account the process-limiting variables in applications where responses are highly non-linear. In a preferred embodiment, the method comprises determining an actual rate of change of a performance limiting process parameter; calculating a predicted rate of change for the performance limiting process parameter for a predetermined future time interval; and adjusting a setpoint for the control variables to optimize the process while taking into account the performance limiting process parameter using the actual rate of change and the predicted rate of change.

### BACKGROUND OF THE INVENTION

1. Field of the Invention

The present invention relates to the field of process control. More specifically, the present invention relates to process control systems that manipulate setpoints of manipulated variables to optimize a process being controlled by using predicted rates of change of process performance limiting parameters.

2. Description of the Related Art

Process control systems are used in a variety of situations with a variety of process control methods to sense process conditions and adjust process operating parameters in an attempt to optimize performance for given sets of goals. Many current conventional process control systems use static representations of the process to be controlled and do not provide for optimizing the process being controlled by automatically making changes in the process control model being used in real time. U.S. Pat. No. 6,230,486 issued to Yasui, et al. for “Plant control system” is illustrative.

In the control art, traditional feedback controllers include linear controllers, such as the proportional (P) controller, the proportional-integral (PI) controller, or the proportional-integral-derivative (PID) controller, as well as non-linear controllers, such as fuzzy logic (FL) controller. Some of these control systems have been around since the 1930s and are generally not dynamically adaptive

Linear control methods such as PID may use the rate of change of an error signal, e.g. the difference between a process variable and the corresponding setpoint, to aid in process control. By way of example, PID methods generally examine current values that reflect differences between a current control setpoint value and its desired value, the accrued value of that error for that setpoint which can be an integral of those differences over a time period, and the current rate of change of that difference, i.e. its derivative or rate of change. These PID algorithms do not seek to predict a future rate of change or use a predicted future rate of change to affect current setpoint values for one or more manipulated control variables.

Dynamically adaptive control methods are employed in some prior art process control systems such as with minimum variance controllers. However, adaptive control systems are often computationally complex and/or sensitive to the choice of the input-output delays and model order selection. U.S. Pat. No. 6,122,557 issued to Harrell, et al. for “Non-linear model predictive control method for controlling a gas-phase reactor including a rapid noise filter and method therefor” is illustrative and teaches using a nonlinear predictive model to calculate a future state for process control.

Minimum variance control algorithm process control systems are generally more effective for multivariate process control systems. In these systems, overall variance, i.e. a measure of changes in a process variable from its setpoint over a period of time, is treated as a weighted sum of the variances computed for each individual process variable. As with PID, minimum variance control algorithms do not seek to predict a future rate of change or use a predicted future rate of change to affect current setpoint values.

Some prior art has proposed using future values in process control. For example, in “Neuro-predictive process control using on-line controller adaptation” by Alexander G. Parlos and Sanjay Parthasrathy, Paper ID ACC00-ASME1005, a technique is proposed using neural networks. The neural networks are integrated with conventional controller structures to create a predictive control of complex process systems. U.S. Pat. No. 6,243,663 issued to Baty , et al. teaches a “Method for simulating discontinuous physical systems.” In Baty '663, a process control system is claimed comprising a process correcting routine that comprises a predictor which uses approximated future states of a physical process, described in terms of a set of predicted process parameters, and a corrector which compares the set of predicted process parameters to the set of desired process parameters. The Baty '663 process correcting routine alters a set of adjustable control parameters such that the physical process is directed more closely along a desired process path. Neither of these teach or suggest using predicted rates of change in process parameters in generating current setpoint values for manipulated process variables.

U.S. Pat. No. 6,112,126 issued to Hales et al. for “Adaptive object-oriented optimization software system,” fully incorporated by reference herein, teaches a process control optimization system that uses dynamically modeled representations of the process to be controlled, thus providing for automatically optimized changes in the process control model being used in real time. Hales '126 provides a process control optimization system that, in substantial measure, uses non-static representations of the process to be controlled and provides for changes in the process control model being used in real time.

### BRIEF DESCRIPTION OF THE DRAWINGS

These and other features, aspects, and advantages of the present invention will become more fully apparent from the following description, appended claims, and accompanying drawings in which:

FIG. 1 is a schematic of an exemplary embodiment of a system of the present invention; and

FIG. 2 is a flowchart of an exemplary embodiment of the present invention.

### DETAILED DESCRIPTION OF THE PREFERRED EMBODIMENT

In general, throughout this description, if an item is described as implemented in software, it can equally well be implemented as hardware.

As used herein below, a “process performance limiting parameter” is defined as a programmatic representation of a measure of a physical limitation in the process being controlled, by way of example and not limitation such as environmental pressure or temperature. As further used herein below, a “manipulated control variable” is defined as a variable directly related to and/or controlling of a controllable device such as a machine, by way of example and not limitation such as a variable used to control a motor speed.

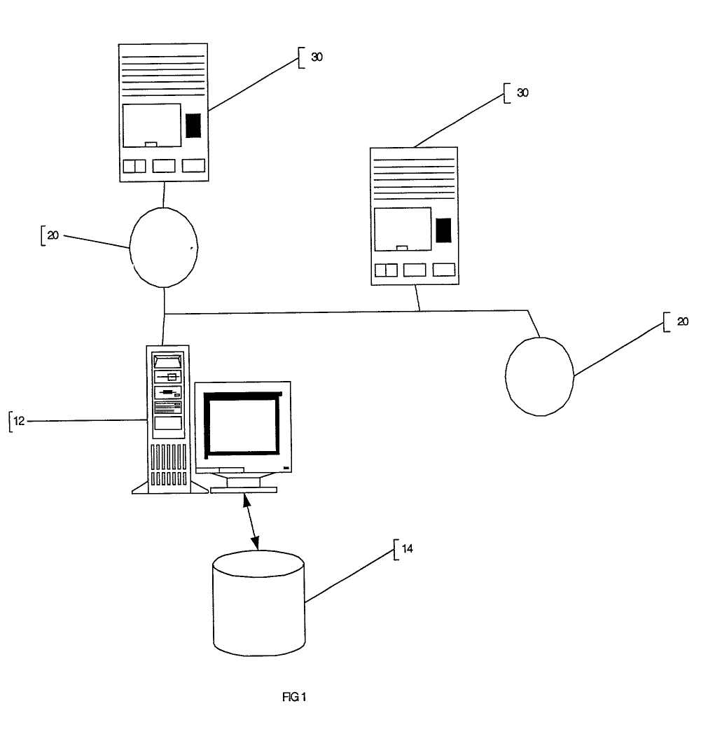

Referring now to FIG. 1, process control software 10 executes in process controller 12. As will be familiar to those of ordinary skill in the process control arts, process controller 12 may be a microprocessor-based system such as a personal computer, a laptop computer, or a series of such computers operatively connected such as by a local area network, as will be familiar to those of ordinary skill in the distributed data processing arts; a dedicated logic controller, such as a programmable array logic controller; a specialized controller, such as a controller using application specific integrated circuits; or the like, or a combination thereof. Additionally, process controller 12 may further comprise specialized circuits including application specific integrated circuits, fuzzy logic integrated circuits, neural network integrated circuits, and the like, or combinations thereof with which to accomplish at least a portion of modeling the process being controlled.

Process controller 12 additionally comprises data store 14 which may comprise RAM, NVRAM, magnetic media, electronic media, optical media, and the like, or any combination thereof. Process control software 10 executing in process controller 12 may maintain a set of data comprising past predicted and actual values and other data useful to control process in data store 14.

Additionally, one or more controllable devices 30 are placed at predetermined positions about the process being controlled and are controlled by process control software 10, executing in process controller 12, to obtain a predetermined process goal. In the preferred embodiment, process control software 10 comprises non-linear models to achieve optimization of the process being controlled according to one or more predetermined process goals.

One or more sensors 20 are placed at predetermined positions about the process being controlled. These sensors 20 provide feedback information to process control software 10, by way of example and not limitation including environment pressure and/or temperature, current, voltage, process specific pressure, controllable device 30 state information, and the like, or a combination thereof. Additionally, sensors 20 may be associated with one or more controllable devices 30, be free standing, or may be embedded in a controllable device 30.

Process control software 10 is operatively connected to sensors 20 and controllable devices 30 using any of a number of equivalent methods, as will be familiar to those of ordinary skill in the process control arts, including by way of example and not limitation wire-based and wireless methods.

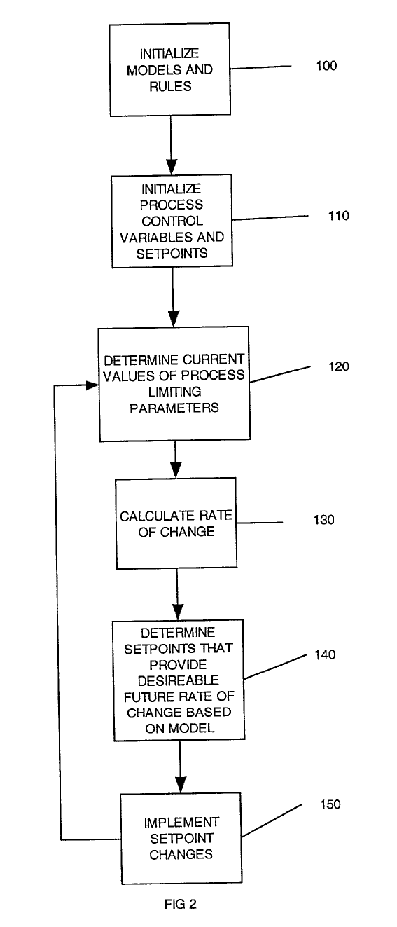

In the operation of an exemplary embodiment, referring now to FIG. 2, the present application is useful for applications where responses are highly non-linear. The present invention uses past and current rates of change of process performance limiting parameters to predict future values of the rates of change of those process performance limiting parameters. These parameters may include temperature, pressure, speed, weight, density, and the like, or any combination thereof.

In the preferred embodiment, the method of the present invention is an iterative one over time. Process control software 10 first determines the actual rate of change of at least one performance limiting process parameter. Process control software 10 then calculates a predicted rate of change for the performance limiting process parameter for a predetermined future time interval and adjusts a setpoint value for one or more manipulated variables to optimize the process being controlled, taking into account the performance limiting process parameter as well as the actual rate of change and the predicted rate of change of the performance limiting process parameter. Further, in a preferred embodiment, process control software 10 maintains the rate of change of the performance limiting process parameter within a predetermined range.

At a beginning point in time, process control software 10, including its non-linear models, is initialized at steps 100, 110. As will be familiar to those of ordinary skill in the software process modeling arts, non-linear modeling techniques may comprise genetic algorithms, neural networks, expert systems, optimizers, and the like, or any combination thereof. In the preferred embodiment, the non-linear modeling technique used is the adaptive object-oriented optimization software system taught by U.S. Pat. No. 6,112,126. According to the teachings of U.S. Pat. No. 6,112,126, a user first initializes expert system rules associated with the adaptive object-oriented optimization software system to be used in the process control system for the process to be controlled. In the present invention, non-linear neural-network models are then configured to predict the rates of change of the process limiting parameters desired to be monitored. The expert rules and neural-network models are continuously refined over time by the adaptive object-oriented optimization software. In currently envisioned alternative embodiments, non-linear models may be generated in whole or in part using application specific integrated circuits, fuzzy logic integrated circuits, neural network integrated circuits, and the like, or combinations thereof to create models of the process being controlled.

Once process control software 10 is initialized, process control software 10 determines the actual rates of change at step 120 of a predetermined number of performance limiting process parameters.

Based on the determined rate of change, process control software 10 continuously models the process, including process conditions related to process performance limiting variables, to calculate a new predicted rate of change for the process' process performance limiting variables being monitored. At step 140, process control software 10 determines setpoints that provide a desirable future rate of change based on a model. Process control software 10 uses a predicted rate of change for that process' process performance limiting variables for a predetermined future period, by way of example and not limitation an incremental portion of time such as milliseconds, seconds, or minutes into the future.

In a preferred embodiment, process control software 10 uses the current state of the process and the current setpoint values of manipulated variables then being implemented in its non-linear models to generate a new set of predicted rate of change of process limiting variables. However, the rates of change may be further constrained by process control software 10 to maintain the rates of change within predetermined ranges of values.

Once the predicted rate of change of one or more process limiting variables is calculated, the method of the present invention generates one or more new values for setpoints for the manipulated variables. As opposed to the prior art, the present invention therefore determines and modifies setpoint values of manipulated variables to be used in a current time frame by calculating those values based, at least in part, on current and predicted rates of change of process limiting variables that are affected by those manipulated variables. In a currently preferred embodiment, the determination of these new setpoint values is achieved using genetic algorithms such as those in taught by U.S. Pat. No. 6,112,126. The adaptive object-oriented optimization software system of U.S. Pat. No. 6,112,126 inserts possible setpoint changes into a model and evaluates the desirability of using those changes according to a prescribed fitness function, which may comprise predetermined values.

The new setpoint values of manipulated variables that result in the most desirable predicted rate of change of process limiting variables are then implemented at step 150.

In a currently preferred embodiment, modeling future outcome of changes in present process limiting variables helps avoid instabilities in the process being controlled. Using the predicted values of the rates of change, process control software 10 may further calculate the effect of the changes just made to current setpoint values of manipulated variables on the next predicted rate of change values of process limiting variables to be used. Process control software 10 may then incorporate the calculated effects into its non-linear models to better avoid upsets and/or degradations in the performance of the process as a whole.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A method for determining a setpoint for a manipulated variable for a process being controlled, the determination based at least in part on one or more performance limiting process parameters, comprising:
a. determining an actual rate of change of a performance limiting process parameter;
b. calculating a predicted rate of change for the performance limiting process parameter for a predetermined future time interval; and
c. adjusting a setpoint for the manipulated variable to optimize the process being controlled to reflect a current value of the performance limiting process parameter, the actual rate of change of the performance limiting process parameter, and the predicted rate of change of the performance limiting process parameter.

2. The method of claim 1 wherein the rate of change of the performance limiting process parameter is maintained by the process control software to stay within a predetermined range of rate of change values.

3. The method of claim 1 wherein the predicted rate of change in step (b) is calculated using non-linear modeling techniques.

4. The method of claim 3 wherein the non-linear modeling techniques comprise neural network techniques, expert system techniques, optimizer techniques, use of application specific integrated circuits, use of fuzzy logic integrated circuits, use of neural network integrated circuits, and combinations thereof.

5. The method of claim 3 wherein the non-linear modeling technique is an adaptive object-oriented optimization software system as described in United States Patent U.S. Pat. No. 6,112,126, wherein:
a. new setpoint values of manipulated variables are determined according to U.S. Pat. No. 6,112,126, the determination comprising inserting possible setpoint changes into a model and evaluating desirability of the setpoint change according to a predetermined fitness function; and
b. implementing the new setpoint values of manipulated variables that result in a most desirable predicted rate of change of process limiting variables.

6. A system for process control, comprising:
a. a process controller comprising a processing unit and data store;
b. a controllable device operatively connected to the process controller;
c. a sensor operatively connected to the process controller;
d. data stored in the data store comprising values representative of actual and predicted rates of change of at least one performance limiting process parameter; and
e. process control software executing in the process controller, the process control software capable of calculating a predicted rate of change for the performance limiting process parameter for a predetermined future time interval and adjusting a setpoint for a manipulated variable to optimize a process being controlled, the adjusted setpoint reflecting a current value of the performance limiting process parameter, the actual rate of change of the performance limiting process parameter, and the predicted rate of change of the performance limiting process parameter.

7. The system of claim 6 wherein the process controller is selected from the group of process controllers consisting of personal computers, laptop computers, a plurality of computers operatively interconnected, dedicated logic controllers, programmable array logic controllers, controllers using application specific integrated circuits, application specific integrated circuits, fuzzy logic integrated circuits, neural network integrated circuits, and combinations thereof.

8. The system of claim 6 wherein the sensor is selected from the group of sensors consisting of discrete sensors associated with a controllable device, free standing sensors, and sensors embedded in a controllable device.

9. The system of claim 6 wherein the sensor provides feedback information to the process control software.

10. The system of claim 9 wherein the feedback information comprises data representative of environmental pressure, environmental temperature, current, voltage, process specific physical parameters, and controllable device state information.

11. The system of claim 6 wherein the process control software comprises non-linear modeling.

12. The method of claim 11 wherein the non-linear models comprise neural networks, expert systems, and optimizers.

13. The method of claim 11 wherein the process control software comprises an adaptive object-oriented optimization software system as described in United States Patent U.S. Pat. No. 6,112,126.

14. A system for process control, comprising:
a. means for controlling a process, the means for controlling a process further comprising:
i. means for processing data; and
ii. means for storing data, the data comprising data representative of actual and predicted rates of change of a performance limiting process parameter;
b. a controllable device operatively connected to the means for controlling a process;
c. means for sensing a condition, the means for sensing operatively connected to the means for process control; and
d. process control software, operative in the data processing means, for obtaining a sensed condition for the means for sensing, calculating a predicted rate of change for the performance limiting process parameter for a predetermined future time interval, and adjusting a setpoint for a manipulated variable to optimize a process being controlled, the adjusted setpoint reflecting both the performance limiting process parameter actual rate of change and the performance limiting process parameter predicted rate of change.

15. The system of claim 14 further comprising means for generating non-linear models to achieve optimization of the process being controlled according to one or more predetermined process goals.

16. A computer program embodied within a computer-readable medium created using the method of claim.
